(19) United States
(12) Patent Application Publication
(10) Pub. No.: US 2003/0233512 A1
(43) Pub. Date: Dec. 18, 2003

(54) Managing option information in a combination VCR/DVD player

(75) Inventor: Yong Jin Lee, Osan (KR)

Correspondence Address: FLESHNER & KIM, LLP, P.O. Box 221200, Chantilly, VA, 20153-1200, US

(73) Assignee: LG ELECTRONICS INC.

(21) Appl. No.: 10/338,757

(22) Filed: Jan. 9, 2003

(30) Foreign Application Priority Data
Jun. 1, 2002 (KR) 30919/2002

(51) Int. Cl. G06F 12/00; G06F 12/14; G06F 12/16; G06F 13/28

(52) U.S. Cl. 711/103; 711/102; 711/105

(57) ABSTRACT

Embodiments of the present invention relate to an apparatus. The apparatus may include a power source, a first device, a second device, and/or a read-only-memory. The first device may be powered by the power source. The second device may be powered by the power source. The read only memory may be coupled to the first device and the second device. The first device may include a random-access-memory. The second device may include a second random access memory. The first device may be configured to selectively load data from the read-only-memory to the first random access memory. The second device may be configured to selectively load data from the read-only-memory to the second random access memory.

### BACKGROUND OF THE INVENTION

1. Field of the Invention

The present invention generally relates to electronics.

2. Background of the Related Art

Over the last century, electronics has played an important role in entertainment. For instance, as a result of the advent of radio, audio programming (i.e., radio programs) could be broadcasted to large amounts of people. Throughout the evolution of electronics, televisions were invented. Televisions were greatly appreciated by consumers, because video and audio data (i.e., television programs) could be broadcasted to large amounts of people. Additional developments in electronics allowed for players and recorders (i.e., CD players or tape recorders) to be used to record and/or playback audio and/or video signals on demand. Accordingly, these players or recorders did not tie viewers or listeners to broadcasting times of television programs or radio programs.

However, as the electronics industry has evolved and competition has increased, there has been a desire to reduce the amount of space that a consumer electronic device occupies. Further, there has been a desire, by consumers, to lower the price of consumer appliances to make them more affordable.

### SUMMARY OF THE INVENTION

Objects of the present invention at least include overcoming the disadvantages of the related art. Embodiments of the present invention relate to an apparatus. The apparatus may comprise a power source, a first device, a second device, and/or a read-only-memory. The first device may be powered by the power source. The second device may be powered by the power source. The read only memory may be coupled to the first device and the second device. The first device may comprise a random access memory. The second device may comprise a second random access memory. The first device may be configured to selectively load data from the read-only-memory to the first random access memory. The second device may be configured to selectively load data from the read-only-memory to the second random access memory.

For example, an apparatus may include both a DVD player and a video cassette recorder. Because the DVD player and the video cassette recorder may be included in the same consumer electronic module, many of the parts can be shared. In particular, a read-only-memory (i.e., a EEPROM) may be used for both a DVD player and a video cassette recorder. This sharing of read-only-memory has several advantages. One notable advantage is that the cost of manufacturing a combination DVD player and video cassette recorder can be reduced. This cost savings can be passed onto the consumer. Further, by combining parts in a combination VCR and DVD player, an average size of electronic components can be reduced. This is also desirable for consumers because smaller consumer electronic appliances are more convenient for users.

Additional advantages, objects, and features of the invention will be set forth in part in the description which follows and in part will become apparent to those having ordinary skill in the art upon examination of the following or may be learned from practice of the invention. The objects and advantages of the invention may be realized and attained as particularly pointed out in the appended claims.

### BRIEF DESCRIPTION OF THE DRAWINGS

FIGS. 1 and 2 are exemplary block diagrams illustrating apparatuses for managing option information in composite VCR and DVDPs.

FIG. 3 is an exemplary flow chart illustrating a process for storing phase generator data.

FIG. 4 is an exemplary flow chart illustrating a process of a method for managing option information.

### DETAILED DESCRIPTION OF PREFERRED EMBODIMENTS

A composite apparatus may compound a (Video Cassette Recorder) VCR and a (Digital Video Disc Player) DVDP as one apparatus. A microcomputer of a VCR in a composite apparatus may carry out a basic control performance carried out by each microcomputer. In a composite of a VCR and a DVDP, a first storage unit may be installed in the VCR unit to store option information of the VCR and a second storage unit may be installed in a DVDP unit to store option information of the DVDP. For example, a VCR and DVDP may store option information independently.

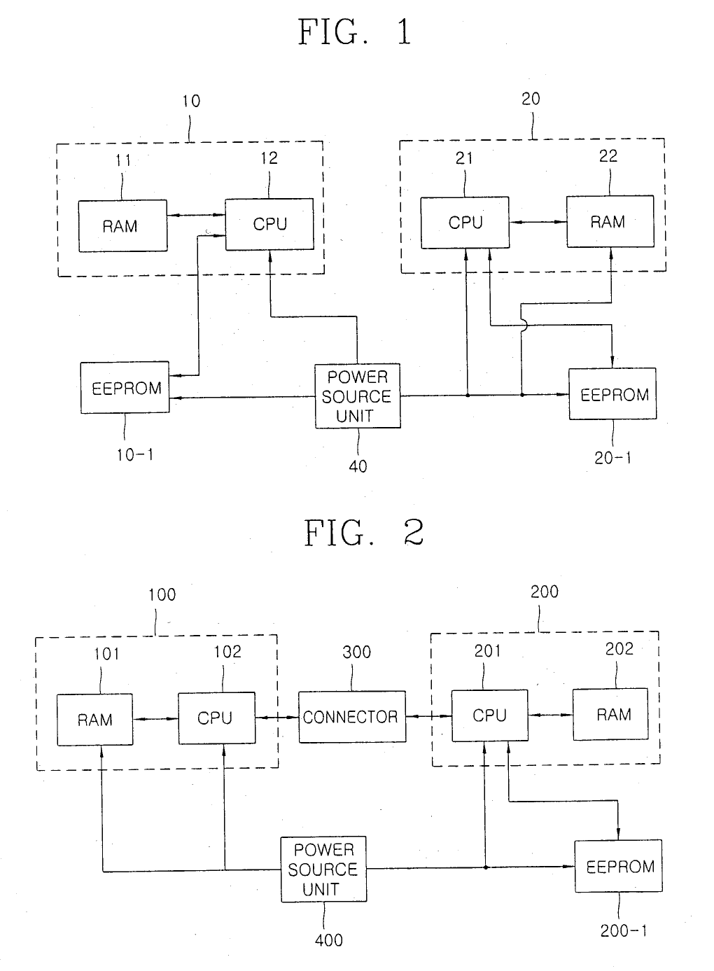

Exemplary FIG. 1 is a block diagram illustrating an apparatus for managing option information in a composite apparatus of a VCR and a DVDP. An apparatus for managing option information in a composite of a VCR and a DVDP may comprise an electrically erasable programmable read-only memory (EEPROM) 10-1 installed at the VCR unit (not shown) and may store option information of the VCR unit. A composite may receive power from power source unit 40. Microcomputer 10 may be installed at a VCR unit in a composite VCR and DVDP and may control a driving of the VCR unit and may receive option information of the VCR unit from EEPROM 10-1. EEPROM 20-1 may be installed in DVDP unit (not shown) in a composite VCR and DVDP and may receive power from power source unit 40 and may store option information of a DVDP unit. Microcomputer 20 may be installed in a DVDP unit in a composite VCR and DVDP and may control a driving of the DVDP unit and may receive option information of the DVDP unit from EEPROM 20-1. First microcomputer 10 may include a central processing unit 12 and a random access memory (RAM) 11. Second microcomputer 20 may include central processing unit 21 and RAM 22

First microcomputer 10 may be installed in a VCR unit in a composite VCR and DVDP. First microcomputer 10 may control driving of a VCR unit. First microcomputer 10 may receive option information of a VCR unit from EEPROM 10-1 when a power source of a composite VCR and DVDP is applied. Second microcomputer 20 may be installed in a DVDP unit, may control driving of the DVDP unit, and may receive option information of the DVDP unit from EEPROM 20-1. Option information of a VCR and a DVDP may be displayed on a screen. EEPROM 10-1 and EEPROM 20-1 may independently read option information of a VCR unit and a DVDP unit. Accordingly, two EEPROMs (20-1 and 10-2) are financially costly and contribute to a large size of a composite apparatus.

Embodiments relate to an apparatus for managing option information in a composite VCR and DVDP and/or a related method thereof. In embodiments, one storage unit may be for storing option information of both a VCR unit and a DVDP of a composite VCR and DVDP. A microcomputer of a VCR unit or a microcomputer of a DVDP unit may receive either option information of the VCR unit or option information of the DVDP unit. Accordingly, in embodiments, costs of a composite VCR and DVDP may be reduced. Further, in embodiments, a size of composite apparatus may be minimized. Embodiments relate to an apparatus and/or method for managing option information in a composite VCR and DVDP.

FIG. 2 is an exemplary block diagram illustrating an apparatus for managing option information in a composite VCR and DVDP according to embodiments of the present invention. An apparatus for managing option information of a composite VCR and DVDP may comprise a connector 300, a microcomputer 100, one EEPROM 200-1, and/or a microcomputer 200. Microcomputer 100 may be electrically connected to connector 300 and installed in a VCR unit (not shown) of a composite VCR and DVDP. Microcomputer 100 may be for controlling driving of a VCR unit and may be for receiving option information of a VCR unit by outputting a request signal through connector 300 when a composite VCR and DVDP is reset. Microcomputer 200 may be electrically connected to connector 300 and may be installed in a DVDP unit of a composite VCR and DVDP. Microcomputer 200 may be for controlling driving of a DVDP unit. Microcomputer 200 may be for reading option information of a VCR unit from EEPROM 200-1 installed in a DVDP unit based on a request signal from microcomputer 100 installed in the VCR unit. Microcomputer 200 may be for outputting read option information to microcomputer 100 of a VCR unit. First microcomputer 100 may include a central processing unit 102 and/or a random access memory (RAM) 101. Second microcomputer 200 may include central processing unit 201 and RAM 202.

First central processing unit 102 of first microcomputer 100 may be installed in a VCR unit of a composite VCR and DVDP. First central processing unit 102 may control driving of a VCR unit. First central processing unit 102 may generate a request signal if a composite apparatus of a VCR and a DVDP is reset. First central processing unit 102 may output a generated request signal to a second central processing unit 201, which may be installed in a DVDP unit (not shown) of a composite VCR and DVDP through first connector 300.

Second central processing unit 201 may be installed in a DVDP unit. Second central processing unit 201 may control driving of a DVDP unit. Second central processing unit 201 may discriminate option information of a VCR unit between option information of a DVDP unit stored in EEPROM 200-1 in accordance with a request signal of first microcomputer 100. Second central processing unit 201 may output read information to first central processing unit 102. Power source unit 400 may supply power to first microcomputer 100, second microcomputer 200, and EEPROM 200-1. EEPROM 200-1 may be divided into two storage regions to separately store option information of a DVDP unit and a VCR unit. Option information of a DVDP unit may be recorded in one storage region and option information of a VCR unit may be recorded in another storage region.

Option information of a DVDP unit may include information about existence of a digital theater system (DTS), information about existence of a video compact disk (VCD) replay, information about existence of a MP3 (MPEG 1 layer 3) file replay, information about existence of a selection of a phase alternation by line system (PAL)/a national television system committee (NTSC), and/or information about existence of a super video home system (S-VHS) output. The option information of a VCR unit may include phase generator (PG) data, original equipment manufacture (OEM) buyer information, auto clock setting system (ACSS) on/off information, information about existence of a G-code, and/or information about existence of a front-jack. OEM-buyer information may be a remote controller code and on-screen display (OSD) format information.

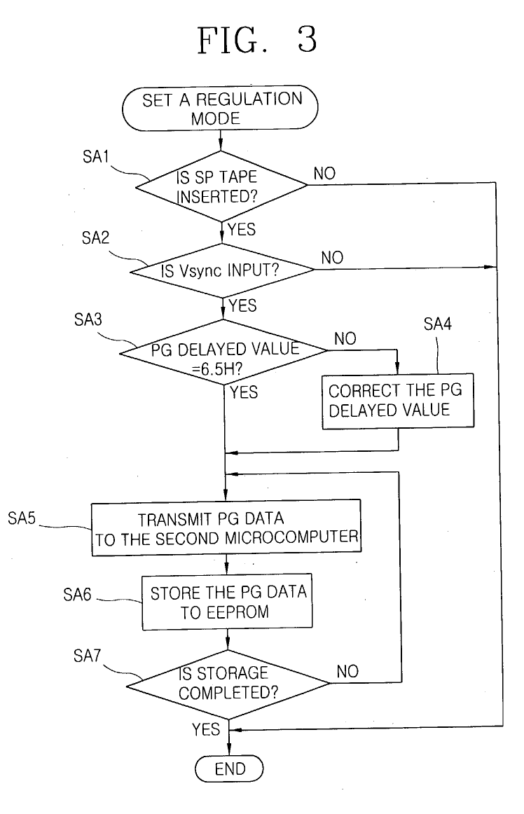

Original equipment manufacture (OEM) buyer information, auto clock setting system (ACSS) on/off information, information about existence of a G-code, and/or information about existence of a front-jack may be stored at a corresponding address of EEPROM 200-1 by setting an arbitrary storage mode. PG data information may be generated if first microcomputer 100 sets an additional PG data regulation mode and a set value is stored in a corresponding address of EEPROM 200-1 through an exemplary process illustrated in FIG. 3. PG data may be stored in a composite apparatus and the composite apparatus may be sold to a consumer.

FIG. 3 is an exemplary flow chart illustrating a process for storing PG data according to embodiments of the present invention. Embodiments relate to a method for storing PG data information during a production process. In a VCR unit, a tape for standard play may record a vertical synchronization signal (Vsync) at a 6.5H point from a bottom of a track. When the tape is replayed, a falling edge of a video switching signal (i.e. a signal of 30 Hz generated at a time when a drum motor (not shown) rotates), may be regulated to be switched at a more forward point than 6.5H. This may be called a PG regulation.

A video set may have its own PG data so that a video switching signal and a vertical synchronization signal may maintain the 6.5H point correctly, regardless of an error of a PG sensor installed at a motor. A motor for driving a drum may read a signal recorded in a tape and may record a signal to the tape. Accordingly, a regulation mode for PG data may be set at a production process. PG data generated after setting a regulation mode may be stored at a corresponding region of EEPROM 200-1. Regulation mode may confirm that a tape for only standard play is inserted and the vertical synchronization signal (Vsync) is input and then corrects PG data (PG delayed value) to 6.5H (SA1-SA4). PG data may be a delayed value so that a video switching signal may be generated at a more forward point than a vertical synchronization signal (Vsync) of 6.5H.

Central processing unit 101 of first microcomputer 100 of a VCR unit may transmit PG data to central processing unit 201 of second microcomputer 200 of a DVDP unit. Central processing unit 201 of a DVDP unit may temporarily store PG data in RAM 202. Central processing unit 201 may store temporarily-stored PG data in a corresponding region of EEPROM 200-1. This process may be repeated. If storage of PG data in EEPROM 200-1 is not completed, PG data may be transmitted to central processing unit 201 of second microcomputer 200 of DVDP unit (SA5-SA6). This process may be repeated (SA5-SA7).

Option information of a VCR unit and option information of DVDP unit may be separately stored in EEPROM 200-1 and may be sold to a consumer. When an initial power source is supplied to a composite apparatus, first microcomputer 100 of VCR unit may be reset by supplying power to a composite apparatus after an elapse of a predetermined time from a point of time of an interruption of electric power. Accordingly, option information of a VCR and option information of a DVDP which may be temporarily stored in RAMs 101 and 202 may be deleted. To operate a VCR and a DVDP, option information of the VCR that may be stored in EEPROM 200-1 may need to be stored in RAM 101 of first microcomputer 100. Option information of a DVDP which may be stored in EEPROM 200-1 may need to be stored in RAM 201 of second microcomputer 200.

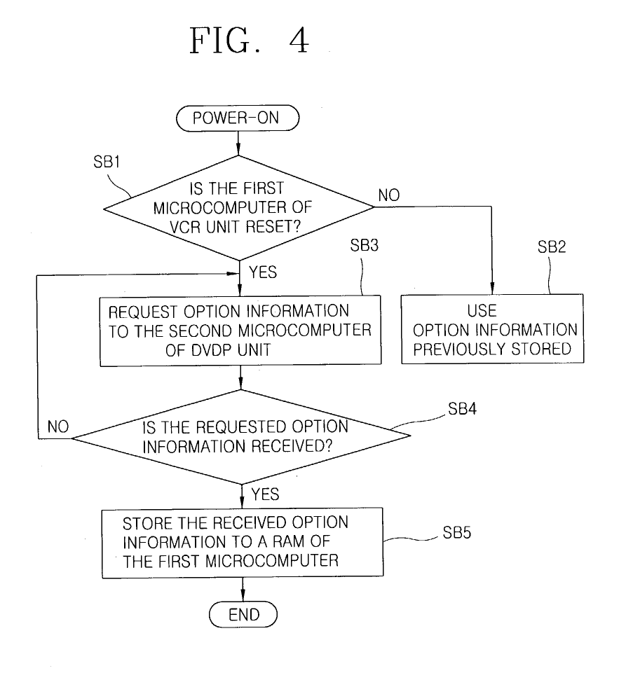

FIG. 4 is an exemplary flow chart illustrating a process for realizing a method for managing option information in a composite apparatus according to embodiments of the present invention. If power is supplied to first microcomputer 100 from power source unit 400 (or a standby power source is continuously supplied), first microcomputer 100 may not reset. Central processing unit 102 of a VCR unit may continuously use option information of a VCR unit previously stored in RAM 101 (SB1, SB2). When a composite VCR and DVDP is restored after a power interruption for a predetermined time (e.g., ten minutes), first microcomputer 100 may reset. During reset, central processing unit 102 may generate a request signal and output a generated request signal to first microcomputer 200 of a DVDP, thereby requesting option information of a VCR unit (SB3).

Central processing unit 201 of a DVDP may read option information of a VCR in a corresponding region of EEPROM 200-1 on the basis of a request signal. Central processing unit 201 may output read option information of a VCR unit to central processing unit 102 of a VCR unit. Central processing unit 102 may receive option information of a VCR unit outputted from central processing unit 201. Central processing unit 102 may store received option information of a VCR unit in RAM 101 of the VCR unit. Central processing unit 102 may refer to option information of a VCR stored in RAM 101 when the VCR is operated (SB4, SB5). In embodiments of the present invention, a EEPROM may be substituted by other memory devices.

In embodiments of the present invention, EEPROM 200-1 may store option information of a DVDP unit and option information of a VCR unit of a composite VCR and DVDP. Accordingly, a microcomputer of a DVDP unit may receive option information of the DVDP unit from a EEPROM installed at a VCR unit. For example, when a composite VCR and DVDP is operated by recovering power, which is interrupted for a predetermined time (e.g., ten minutes), second microcomputer 200 of a DVDP unit may be reset. Central processing unit 201 of a DVDP unit may generate a request signal and output the generated request signal to central processing unit 102, thereby requesting option information of a DVDP unit.

Central processing unit 102 of a VCR unit may read option information of a DVDP in a corresponding region of EEPROM 200-1 installed at an inner portion of the VCR unit on the basis of a request signal. Central processing unit 102 may output read option information of a DVDP unit to central processing unit 201 of the DVDP unit. Central processing unit 201 of a DVDP unit may receive option information of a DVDP unit outputted from central processing unit 102 of a VCR unit. Central processing unit 201 may store received option information of a DVDP unit in a RAM 202 of a DVDP unit. Central processing unit 201 may refer to option information of a DVDP unit stored in RAM 202 when the DVDP unit is operated.

In embodiments of the present invention, either option information of a VCR unit or option information of a DVDP unit may be received from one memory installed at an inner portion of the VCR unit or the DVDP unit of a composite VCR and DVDP. Accordingly, two EEPROMs 10-1 and 20-1 for independently storing option information of VCR unit and option information of DVDP unit do not necessarily need to be used. In embodiments of the present invention, option information of a VCR unit and option information of a DVDP unit may be stored together in one memory and only one EEPROM may be necessary. In embodiments of the present invention, one memory for storing option information of a VCR and option information of a DVDP together may be installed at an inner portion of the VCR or the DVDP of a composite VCR and DVDP, thereby reducing a cost of a composite apparatus and/or minimizing the size of a composite apparatus. Embodiments of the present invention may be applied in a wide variety of composite apparatuses that compound electronic products.

Embodiments of the present invention are for providing an apparatus for managing option information in a composite apparatus and a method thereof, wherein one storage unit for storing option information of a VCR unit and a DVDP unit together is installed in the composite apparatus of the VCR and the DVDP to receive the option information of the VCR unit and/or the DVDP unit.

Embodiments provide an apparatus for managing option information in a composite apparatus, the composite apparatus for compounding a first electronic apparatus and a second electronic apparatus having different performances from each other, the apparatus comprising a storage unit for storing the option information of the first and second electronic apparatuses; a first microcomputer for generating a request signal for the option information of the first electronic apparatus and outputting the generated request signal for the option information; and/or a second microcomputer for reading the option information of the first electronic apparatus stored in the storage unit on the basis of the request signal for the option information and outputting the read option information to the first microcomputer.

Embodiments provide a method for managing option information in a composite apparatus, the composite apparatus for compounding a first electronic apparatus and a second electronic apparatus having different performances from each other, the method comprising the steps of storing the option information of the first and second electronic apparatuses in one memory; requesting the option information to the second electronic apparatus by the first electronic apparatus if the composite apparatus is reset; and/or transmitting the requested option information to the first electronic apparatus from the second electronic apparatus. As the present invention may be embodied in several forms without departing from the spirit or essential characteristics thereof, it should also be understood that the above-described embodiments are not limited by any of the details of the foregoing description, unless otherwise specified, but rather should be construed broadly within its spirit and scope as defined in the appended claims, and therefore all changes and modifications that fall within the metes and bounds of the claims, or equivalence of such metes and bounds are therefore intended to be embraced by the appended claims.

The foregoing embodiments and advantages are merely exemplary and are not to be construed as limiting the present invention. The present teaching can be readily applied to other types of apparatuses. The description of the present invention is intended to be illustrative, and not to limit the scope of the claims.

What is claimed is:

1. An apparatus comprising:
a power source;
a first device powered by the power source;
a second device powered by the power source; and
a read only memory coupled to the first device and the second device, wherein:
the first device comprises a first random access memory,
the second device comprises a second random access memory,
the first device is configured to selectively load data from the read only memory to the first random access memory, and
the second device is configured to selectively load data from the read only memory to the second random access memory.

2. The apparatus of claim 1, wherein the read only memory is coupled to the second device through the first device.

3. The apparatus of claim 2, wherein the second device is configured to selectively load data from the read only memory to the first random access memory through the first device.

4. The apparatus of claim 1, wherein:
the first device comprises a first processor; and
the second device comprises a second processor.

5. The apparatus of claim 4, wherein the first processor and the second processor are coupled.

6. The apparatus of claim 5, wherein the second device is configured to selectively load data from the read only memory to the second random access memory through the first processor and the second processor.

7. The apparatus of claim 1, wherein the read only memory is an electrically erasable programmable read only memory.

8. The apparatus of claim 1, wherein the first device is a video cassette recorder.

9. The apparatus of claim 1, wherein the second device is a optical disc player.

10. The apparatus of claim 1, wherein the apparatus is a module having a combined video cassette recorder and a DVD player, wherein the first device is the DVD player and the second device is the video cassette recorder.

11. The apparatus of claim 10, wherein the read only memory is configured to store at least one of:
information about existence of a digital theater system with the DVD player;
information about existence of a video compact disk replay with the DVD player;
information about existence of a MP3 file replay with the DVD player;
information about existence of a selection of a phase alteration by line system of the DVD player;
phase generator data of the video cassette recorder;
original equipment manufacturer buyer information of the video cassette recorder;
auto clock setting system on/off information of the video cassette recorder;
information about existence of a G-code of the video cassette recorder; and
information about existence of a front-jack of the video cassette recorder.

12. An apparatus for managing option information in a composite apparatus, the composite apparatus for compounding a first electronic apparatus and a second electronic apparatus having different performances from each other, the apparatus for managing option information comprising:
a storage unit configured to store option information of the first electronic apparatus and second electronic apparatus;
a first microcomputer configured to generate a request signal for option information of the first electronic apparatus and configured to output the generated request signal for option information; and
a second microcomputer configured to read option information of the first electronic apparatus stored in the storage unit on the basis of the request signal for option information and configured to output the read option information to the first microcomputer.

13. The apparatus of claim 12, further comprising a connector configured to transmit the option information and the request signal.

14. The apparatus of claim 12, wherein the option information of the second electronic apparatus includes at least one of:
information about existence of a digital theater system (DTS);
information about existence of a video compact disk (VCD) replay;
information about existence of a MP3 (MPEG 1 layer 3) file replay;
information about existence of a selection of a phase alternation by line system (PAL)/a national television system committee (NTSC); and
information about existence of a super video home system (S-VHS) output.

15. The apparatus of claim 12, wherein the option information of the first electronic apparatus includes at least one of:
phase generator (PG) data;
original equipment manufacture (OEM) buyer information;
auto clock setting system (ACSS) on/off information;
information about existence and nonexistence of G-code; and
information about existence and nonexistence of front-jack.

16. The apparatus of claim 15, wherein the OEM-buyer information is composed of a remote controller code and on screen display (OSD) format information.

17. The apparatus of claim 12, wherein the storage unit is installed only in the second electronic apparatus of the composite apparatus.

18. The apparatus of claim 12, wherein the storage unit is installed only in the first electronic apparatus of the composite apparatus.

19. The apparatus of claim 12, wherein the storage unit is an electrically erasable programmable read-only memory (EEPROM).

20. The apparatus of claim 19, wherein the EEPROM is installed only in the second electronic apparatus of the composite apparatus.

21. The apparatus of claim 20, wherein the first microcomputer is installed in the first electronic apparatus of the composite apparatus, and outputs the request signal to the second microcomputer installed in the second electronic apparatus of the composite apparatus if the composite apparatus is reset, thereby receiving the option information of the first electronic apparatus.

22. The apparatus of claim 19, wherein the EEPROM is installed only in the first electronic apparatus of the composite apparatus.

23. The apparatus of claim 22, wherein the first microcomputer is installed in the second electronic apparatus of the composite apparatus and is configured to output the request signal to the second microcomputer installed in the first electronic apparatus of the composite apparatus if the composite apparatus is reset, thereby receiving the option information of the second electronic apparatus.

24. A method for managing option information in a composite apparatus, the composite apparatus for compounding a first electronic apparatus and a second electronic apparatus having different performances from each other, the method comprising:
storing option information of the first and second electronic apparatuses in one memory;
requesting option information to the second electronic apparatus by the first electronic apparatus if the composite apparatus is reset; and
transmitting the requested option information to the first electronic apparatus from the second electronic apparatus.

25. The method of claim 24, wherein the one memory is installed only in the second electronic apparatus of the composite apparatus.

26. The method of claim 25, wherein the step of requesting includes:
generating a request signal from a first microcomputer installed in the first electronic apparatus of the composite apparatus if the composite apparatus is reset; and
outputting the request signal to a second microcomputer installed in the second electronic apparatus.

27. The method of claim 26, wherein the transmitting includes steps of:
reading the option information of the first electronic apparatus previously stored in the one memory of the second microcomputer on the basis of the request signal; and
transmitting the read option information to the first microcomputer.

28. The method of claim 24, wherein the option information of the second electronic apparatus includes at least one of:
information about existence of a digital theater system (DTS);
information about existence of a video compact disk (VCD) replay;
information about existence of a MP3 (MPEG 1 layer 3) file replay; information about existence of a selection of a phase alternation by line system (PAL)/a national television system committee (NTSC); and information about existence of a super video home system (S-VHS) output.

29. The method of claim 24, wherein the option information of the first electronic apparatus includes at least one of:
phase generator (PG) data;
original equipment manufacture (OEM) buyer information;
auto clock setting system (ACSS) on/off information;
information about existence of G-code; and
information about existence of front-jack.
